(19) United States
(12) Patent Application Publication
(10) Pub. No.: US 2007/0246415 A1
(43) Pub. Date: Oct. 25, 2007

(54) Water-treating device capable of supplying calcium

(76) Inventor: Yen-Chou Wang, Taichung City (TW)

Correspondence Address: BANNER & WITCOFF, LTD., 1100 13th STREET, N.W., SUITE 1200, WASHINGTON, DC, 20005-4051, US

(21) Appl. No.: 11/407,033

(22) Filed: Apr. 20, 2006

(51) Int. Cl. C02F 1/66

(52) U.S. Cl. 210/198.1

(57) ABSTRACT

A water-treating device includes an anterior water reservoir; and a posterior treatment unit including a filter unit disposed downstream of the anterior water reservoir, a water-treating agent supply unit having an inlet and an outlet, a clean water collector, a main conduit connected between the filter unit and the clean water collector, a first by-pass conduit connected between the main conduit and the inlet of the water-treating agent supply unit, and a second by-pass conduit connected between the main conduit and the outlet of the water-treating agent supply unit. The water-treating agent supply unit contains a substance that releases a calcium ion to water.

### BACKGROUND OF THE INVENTION

1. Field of the Invention

The invention relates to a water-treating device for producing clean water, more particularly, to a water-treating device that can supply a calcium ion to clean water.

2. Description of the Related Art

As water resources are contaminated seriously due to industrial and agricultural wastes, chlorine has been added to water in an increased amount in order to ensure safeness of tap water. The acidity of tap water is therefore increased.

It is known to use basic substances to neutralize acidic substances contained in water. Corallite is a mineral rock that can produce basic ions such as, calcium, sodium and potassium ions, through electrolysis and sintering processes. One of water-treating agents produced by the aforesaid processes contains 99.5-90% of calcium carbonate, and 0.5-10% of calcium oxide. While the water-treating agent releases a calcium ion when dissolved in water, it does not last long when added to water so that it is necessary to examine frequently the residual amount thereof in the water.

Another water-treating agent is produced from coral sand, conch and oyster shells through a high temperature sintering process, followed by grinding, so as to form particles having a size of less than 100 nanon. The nonoparticles as produced are then formed into a granular water-treating material. Due to strong binding forces among the nonoparticles, the duration of the granular water-treating material is long.

Generally, a water-treating device includes a pump that directs water to a storage reservoir through a filter. In some cases, a water-treating agent, such as a calcium-containing substance, is added directly to the water before entering the storage reservoir. However, with the conventional water-treating device, it is impossible to adjust the concentration of calcium ion released into water from the water-treating agent.

### SUMMARY OF THE INVENTION

Therefore, the main object of the present invention is to provide a water-treating device with a water-treating agent supply unit that is adjustable to regulate the concentration of a calcium ion released from a water-treating agent to treated water.

According to this invention, a water-treating device comprises: a support, an anterior water reservoir mounted on the support; a posterior treatment unit mounted on the support in connection with the anterior water reservoir; and a posterior water reservoir mounted on the support downstream of the posterior treatment unit. The posterior treatment unit includes a filter unit disposed downstream of the anterior water reservoir, a water-treating agent supply unit disposed downstream of the filter unit and having an inlet and an outlet, a clean water collector connected to said posterior water reservoir, a main conduit connected between the filter unit and the clean water collector, a first by-pass conduit connected between the main conduit and the inlet of the water-treating agent supply unit, a second by-pass conduit connected between the main conduit and the outlet of the water-treating agent supply unit, and a flow-regulating valve attached to the first by-pass conduit. The water-treating agent supply unit contains a substance that releases a calcium ion to water.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic elevation view showing a preferred embodiment of the water-treating device according to the present invention;

FIG. 2 is a flow diagram of the water-treating device of FIG. 1;

FIG. 3 is a flow diagram of a posterior treatment unit of the water-treating device of FIG. 1;

FIG. 4 is a perspective view of the posterior treatment unit of FIG. 3; and

FIG. 5 is a sectional view of a first or second container of a water-treating agent supply unit in the water-treating device of FIG. 1.

### DETAILED DESCRIPTION OF THE PREFERRED EMBODIMENT

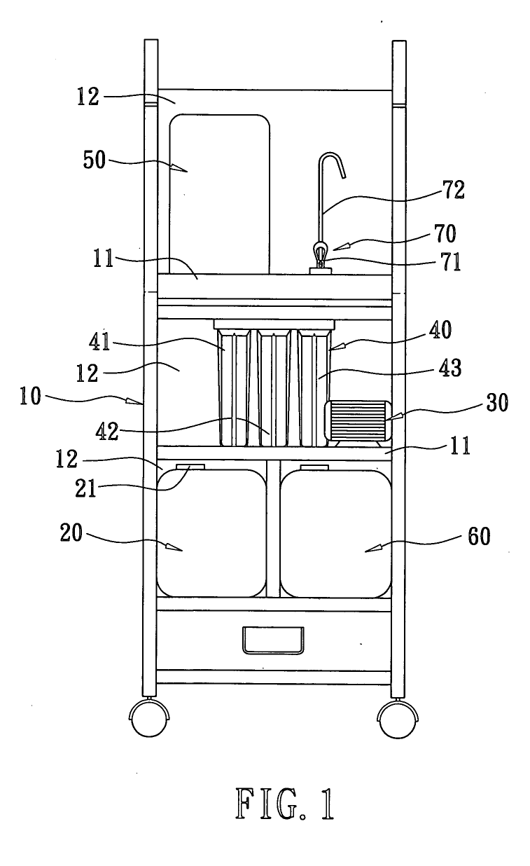

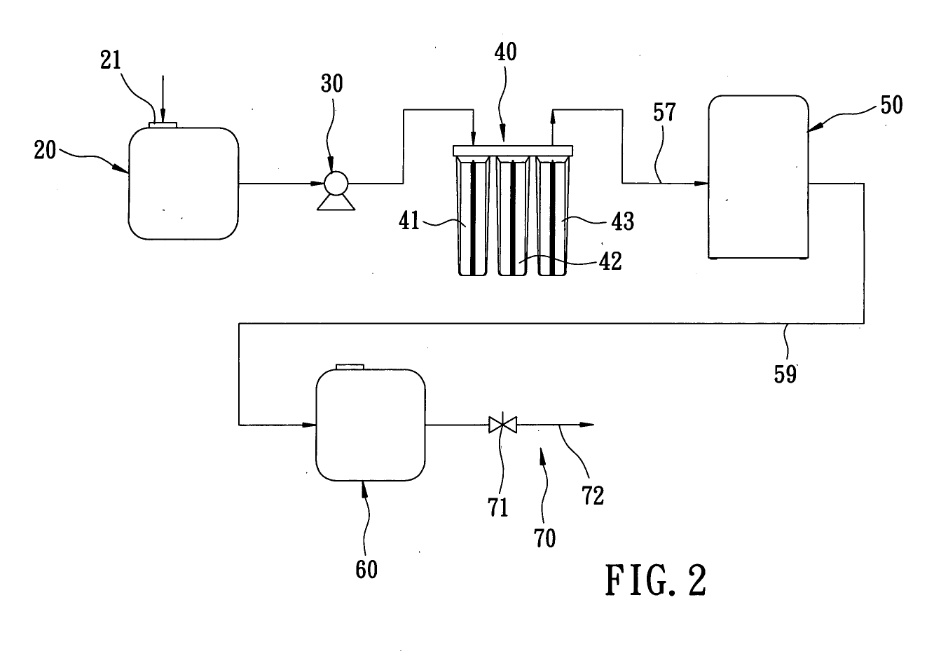

Referring to FIGS. 1 and 2, a water-treating device embodying the present invention is shown to include a support formed as a cabinet 10, an anterior water reservoir 20, a pump 30, an anterior treatment unit 40 disposed downstream of the anterior water reservoir 20, a posterior treatment unit 50 disposed downstream of the anterior treatment unit 40, a posterior water reservoir 60 disposed downstream of the posterior treatment unit 50, and a water delivery unit 70. The cabinet 10 has a plurality of vertically spaced apart plates 11 that divide the cabinet 10 into top, bottom and intermediate compartments 12.

The anterior water reservoir 20 serves to store original water and is disposed in the bottom compartment 12 of the cabinet 10. The anterior water reservoir 20 has a water inlet port 21.

The pump 30 is disposed in the intermediate compartment 12 and downstream of the anterior water reservoir 20 and is connected to the anterior water reservoir 20.

The anterior treatment unit 40 is also disposed in the intermediate compartment 12 and is connected to the pump 30 such that water from the anterior water reservoir 20 can be directed to the anterior treatment unit 40. The anterior treatment unit 40 has a first filter cartridge 41, a second filter cartridge 42, and a third filter cartridge 43. The first filter cartridge 41 has a filtering material, such as, a filter cloth, or a coconut shell carbon, and is used to filter out coarse grain impurities, such as, sand and other large size contaminants. The second filter cartridge 42 contains a metal particulate material (produced by KDF® Fluid Treatment Inc.) to remove ions, such as ions of chlorine, lead, mercury, nickel, chromium, etc. The third filter cartridge 43 contains activated carbon to adsorb micro-particles.

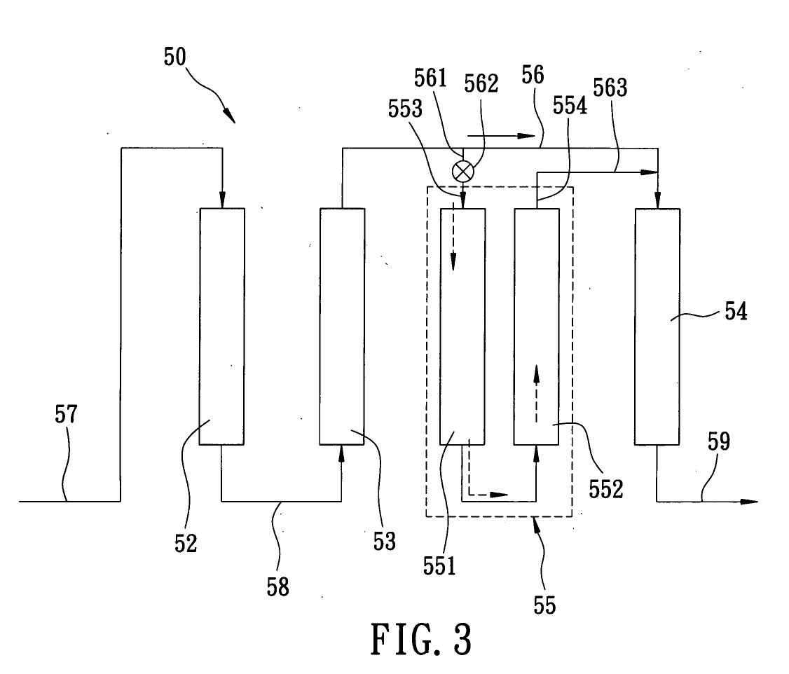

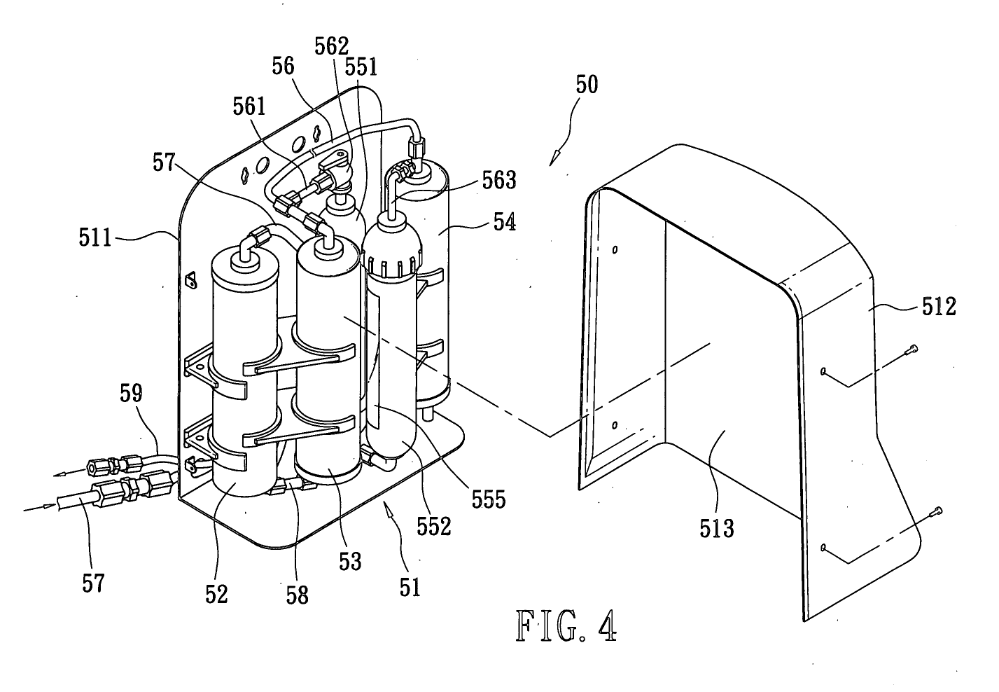

Referring to FIGS. 3 and 4, the posterior treatment unit 50 is disposed in the top compartment 12, and includes a casing 51, a filter unit that includes a first filter section 52 disposed downstream of the anterior water reservoir 20 and a second filter section 53 connected to the first filter section 52, a water-treating agent supply unit 55, a clean water collector 54, a main conduit 56 connected between the second filter section 53 and the clean water collector 54, a pipe 57 connected between the first filter section 52 of the posterior treatment unit 50 and the third filter cartridge 43 of the anterior treatment unit 40, a pipe 58 connected between the first and second filter sections 52, 53, and a pipe 59 connected between the clean water collector 54 and the posterior water reservoir 60.

The casing 51 is composed of a lower part 511 and an upper part 512 which cooperate to confine a receiving space 513 to receive the first and second filter sections 52, 53, the clean water collector 54, and the water-treating agent supply unit 55.

The water-treating agent supply unit 55 includes a first container 551 provided with an inlet 553, and a second container 552 connected in series with the first container 552 and provided with an outlet 554. A first by-pass conduit 561 is connected between the main conduit 56 and the inlet 553 of the first container 551, and a second by-pass conduit 563 is connected between the main conduit 56 and the outlet 554 of the second container 552. A flow-regulating valve 562 is connected to the first by-pass conduit 561.

The first filter section 52 is provided with a foam to screen out coarse impurities, such as, sand and other contaminants. The second filter section 53 has a stack of an activated carbon filter layer and a far infrared ceramic filter layer (not shown). The activated carbon serves to remove bad odor substances, whereas the far infrared ceramic produces a far infrared electromagnetic heat radiation that can activate water. The clean water collector 54 is filled with irregular activated carbon granules that provide a plurality of water passages thereamong (not shown).

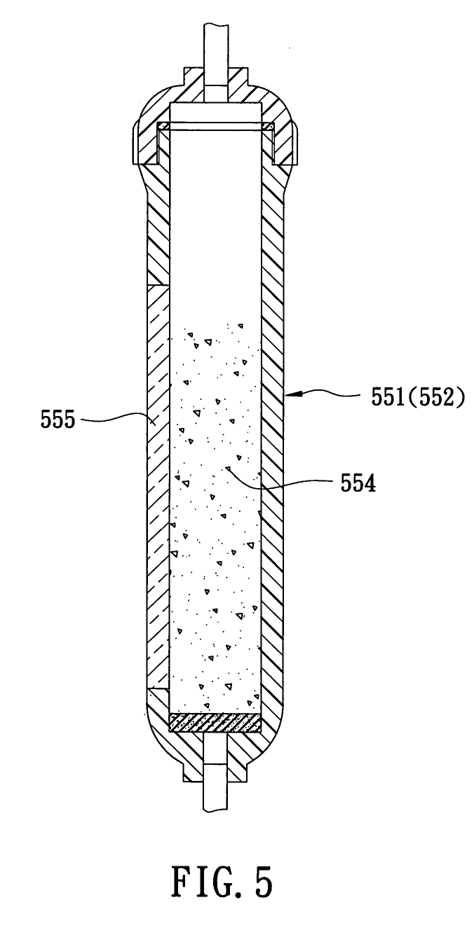

As shown in FIG. 5, each of the first and second containers 551 and 552 of the water-treating agent supply unit 55 is provided with a substance that includes calcium-containing pellets 554 to release calcium ion into water. The calcium-containing pellets 554 are formed by sintering a calcium carbonate-based raw material and are soluble in water to release calcium ion. Each of the first and second containers 551, 552 has a window 555 through which the calcium-containing pellets 554 remaining in the first and second containers 551, 552 can be examined.

The posterior water reservoir 60 is disposed in the bottom compartment 12 and is used to store the water passing through the anterior and posterior treatment units 40, 50.

The water delivery unit 70 has a water discharge tube 72 connected to the posterior water reservoir 60, and a discharge control valve 71 connected to the water discharge tube 72.

Referring once again to FIGS. 2 and 3, when the pump 30 is activated, water is sent to the anterior treatment unit 40 from the anterior water reservoir 20 so that impurities in the water are removed by the first, second and third filter cartridges 41, 42 and 43 of the anterior treatment unit 40. The water from the anterior water reservoir 20 then flows into the posterior water reservoir 60 through the posterior treatment unit 50.

When water flows through the posterior water treatment unit 50, if the flow regulating valve 562 is in a closed position, the water will flow through the first and second filter sections 52, 53 to the clean water collector 54 by passing only through the main conduit 56, and will not pass through the first and second containers 551, 552 of the water-treating agent supply unit 55. In this case, no calcium ion is released to the water flowing through the main conduit 56.

If the flow-regulating valve 562 is in an opened position, the water flowing through the main conduit 56 will be branched so that a portion of the water flows into the first and second containers 551, 552 through the first and second by-pass conduits 561, 563. When the water passes through the first and second containers 551 and 552, calcium ion released from the calcium-containing pellets 554 is dissolved in the water. The quantity of the water flowing through the first and second containers 551, 552 depends upon the degree of opening of the flow-regulating valve 562. As the degree of the opening of the flow-regulating valve 562 can be controlled, the concentration of the calcium ion contained in the water passing through the first and second containers 551, 552 can be adjusted as desired. When the water that contains the calcium ion enters the clean water collector 54, the concentration of the calcium ion is diluted in the clean water collector 54. Therefore, the water collected in the clean water collector 54 may contain a desired calcium ion concentration through an adjustment of the flow-regulating valve 562.

The calcium-containing clean water from the clean water collector 54 is thereafter sent to and stored in the posterior water reservoir 60. The water stored in the posterior water reservoir 60 may be used as drinking water. The user may obtain the drinking water from the water delivery unit 70.

Due to the presence of the water-treating agent supply unit 55 that has the first and second by-pass conduits 561, 563 connected to the main conduit 56, and the flow-regulating valve 562 to adjust the water flowing through the calcium-containing pellets 554 provided in the first and second containers 551, 552, the water-treating device according to the present invention is able to supply clean water which has no calcium, or clean water containing a desired amount of calcium. In addition, since each of the first and second containers 551, 552 is provided with the window 555, the amount of the calcium-containing pellets 554 remaining in the first or second container 551, 552 may be examined conveniently through the window 555 so that the calcium-containing pellets 554 may be added properly to the first and second containers 551, 552.

While the present invention has been described in connection with what is considered the most practical and preferred embodiment, it is understood that this invention is not limited to the disclosed embodiments but is intended to cover various arrangements included within the spirit and scope of the broadest interpretation so as to encompass all such modifications and equivalent arrangements.

I claim:

1. A water-treating device comprising:
a support;
an anterior water reservoir mounted on the support;
a posterior treatment unit mounted on the support in connection with said anterior water reservoir and including a filter unit disposed downstream of said anterior water reservoir, a water-treating agent supply unit disposed downstream of said filter unit and having an inlet and an outlet, a clean water collector, a main conduit connected between said filter unit and said clean water collector, a first by-pass conduit connected between said main conduit and said inlet of said water-treating agent supply unit, a second by-pass conduit connected between said main conduit and said outlet of said water-treating agent supply unit, and a flow-regulating valve attached to said first by-pass conduit, said water-treating agent supply unit containing a substance that releases a calcium ion to water; and
a posterior water reservoir mounted on the support downstream of said posterior treatment unit and connected to said clean water collector.

2. The water-treating device of claim 1, wherein said posterior treatment unit further includes a casing carrying said filter unit, said water-treating agent supply unit, said clean water collector, said main conduit, and said first and second by-pass conduits.

3. The water-treating device of claim 1, further comprising a pump disposed downstream of said anterior water reservoir, and an anterior treatment unit connected between said pump and said filter unit of said posterior treatment unit.

4. The water-treating device of claim 3, further comprising a water delivery unit connected to said posterior water reservoir and having a water discharge tube and a discharge control valve connected to said water discharge tube.

5. The water-treating device of claim 4, wherein said support is formed as a cabinet that has a top compartment, a bottom compartment and an intermediate compartment, said anterior water reservoir being disposed in said bottom compartment, said pump and said anterior treatment unit being disposed in said intermediate compartment, said posterior treatment unit being disposed in said top compartment, said posterior water reservoir being disposed in said bottom compartment.

6. The water-treating device of claim 1, wherein said filter unit includes a first filter section that contains a foam, and a second filter section that contains a stack of an activated carbon layer and a far infrared ceramic layer.

7. The water-treating device of claim 1, wherein said clean water collector includes a plurality of irregular granules of activated carbon.

8. The water-treating device of claim 1, wherein said substance includes calcium-containing pellets that are produced by sintering a calcium carbonate-based raw material and that are soluble in water.
